(19) United States
(12) Patent Application Publication
(10) Pub. No.: US 2012/0260441 A1
(43) Pub. Date: Oct. 18, 2012

(54) MOUTHPIECE WITH DRIVE FORCE CAPABILITY TO PRODUCE EFFECTIVE TEETH CLEANING

(75) Inventors: Kevin A. Miller, Bellevue, WA (US); Ari Lumbantobing, Issaquah, WA (US); Patrick A. Headstom, Seattle, WA (US); Martinus Bernardus Stapelbroek, Frieschepalen (NL)

(73) Assignee: KONINKLIJKE PHILIPS ELECTRONICS N.V., EINDHOVEN (NL)

(21) Appl. No.: 13/514,638

(22) PCT Filed: Nov. 22, 2010
(86) PCT No.: PCT/IB10/55336

§ 371 Date: Jun. 8, 2012

Related U.S. Application Data
(60) Provisional application No. 61/289,609, filed on Dec. 23, 2009.

(51) Int. Cl. A61C 17/22; A46B 9/04

(52) U.S. Cl. 15/22.1

(57) ABSTRACT

The mouthpiece assembly includes a receptacle (12) for receiving teeth therein, with bristles (24) mounted thereon for contacting and cleaning the teeth. The receptacle and the bristles cover at least 4 cm. A drive train (20) drives the receptacle such that the bristles move substantially at right angles toward and away from the surfaces of the teeth, the drive train including a motor (22) which produces sufficient force to produce a minimum bristle tip threshold pressure of 6 Newtons per cm and a maximum of 85 Newtons per cm.

This invention relates generally to mouthpiece-type teeth cleaning appliances, and more specifically concerns particular operational characteristics of the mouthpiece appliance for effective cleaning.

Current embodiments of oral hygiene devices, including power toothbrushes and mouthpieces, are not optimized relative to bristle tip pressure to achieve effective cleaning. This is because actual loading of the appliance to achieve a bristle tip pressure against the teeth is completely controlled by the user. Minimum bristle tip pressure in a power brushing appliance which is effective for cleaning teeth has therefore not heretofore been known. Knowledge of minimum bristle tip pressure for effective teeth cleaning is, however, quite important in order to implement an effective mouthpiece-type teeth cleaning appliance where the user does not have any control over loading of the appliance and hence cannot affect bristle tip pressure against the teeth. The action of the appliance alone must produce the necessary level of bristle tip pressure. In addition to effective bristle tip pressure, it is also important to know the drive force requirements for the appliance drive train to achieve the desired bristle tip pressure for a specific bristle field area and bristle density of the mouthpiece. This drive force information likewise is not currently known, particularly for a mouthpiece which covers a substantial portion of the user's teeth.

The advantages of a mouthpiece teeth cleaning appliance capable of effective teeth cleaning for the entire mouth region or a substantial portion thereof in a very short period of time cannot be presently obtained, given the lack of available information concerning bristle tip pressure and driving force necessary to achieve effective cleaning for particular bristle fields and bristle density.

Accordingly, it would be desirable to determine such information so that an effective mouthpiece appliance with bristle cleaning elements can be developed.

Accordingly, the mouthpiece assembly with effective cleaning capability comprises\ddot{} a mouthpiece receptacle having bristles mounted thereon for contacting and cleaning the teeth, the mouthpiece having at least 4 cm² of bristle field area for contacting the teeth; and a drive train assembly for driving the mouthpiece such that the bristle field moves toward and away from the surfaces of the teeth, the drive train including a motor providing sufficient drive force to produce a minimum bristle tip threshold pressure of 6 Newtons per cm², for a bristle tip density within the range of 3-15%.

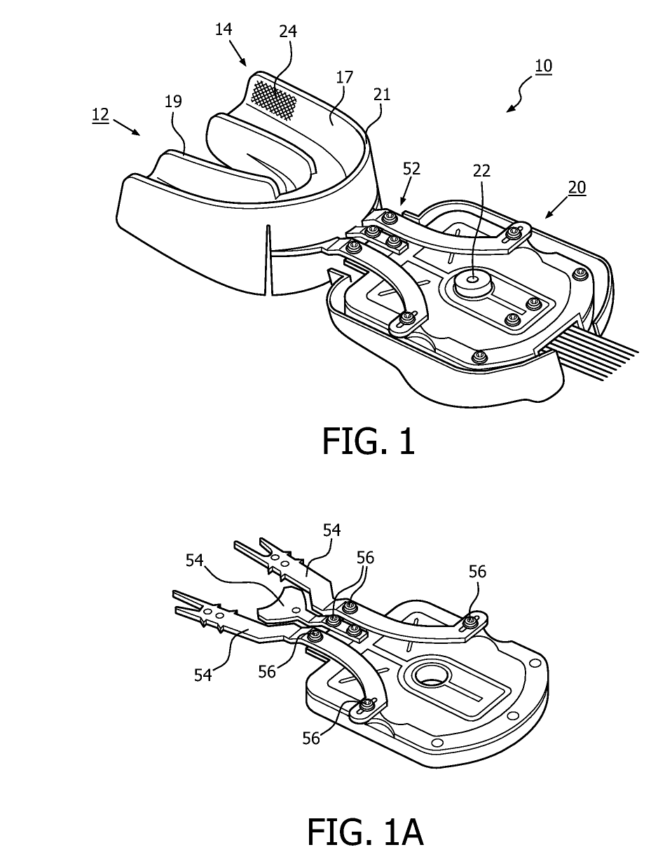

FIG. 1 is a schematic view of a mouthpiece appliance for accomplishing effective cleaning of the teeth.

FIG. 1A is a schematic view of a portion of the apparatus of FIG. 1.

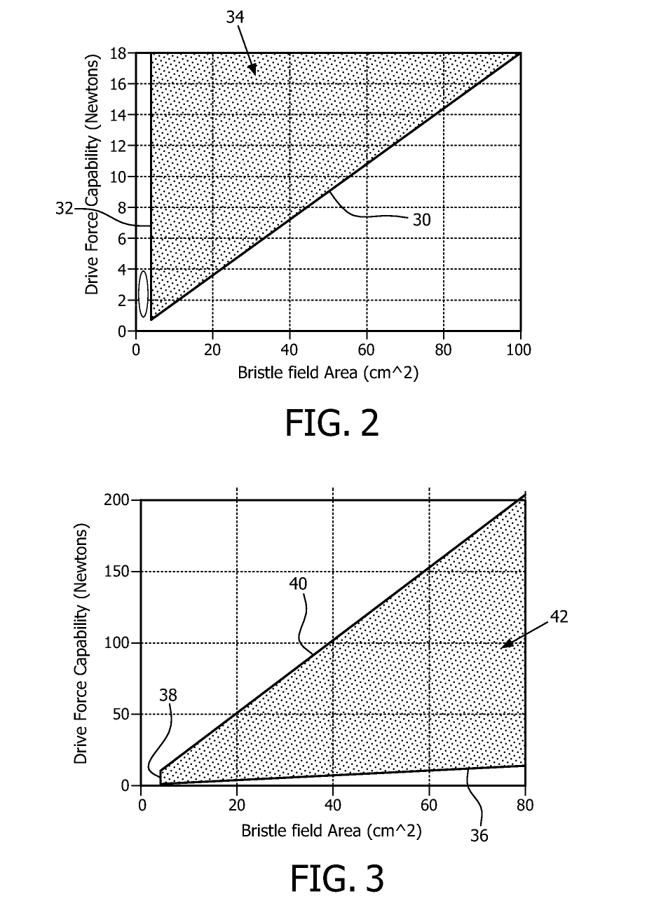

FIG. 2 is a graph showing drive force in Newtons versus a bristle tip area for a 3% bristle density, and showing a minimum drive force.

FIG. 3 is a graph showing the minimum and maximum drive force for various bristle field areas, with a bristle field density of 3%.

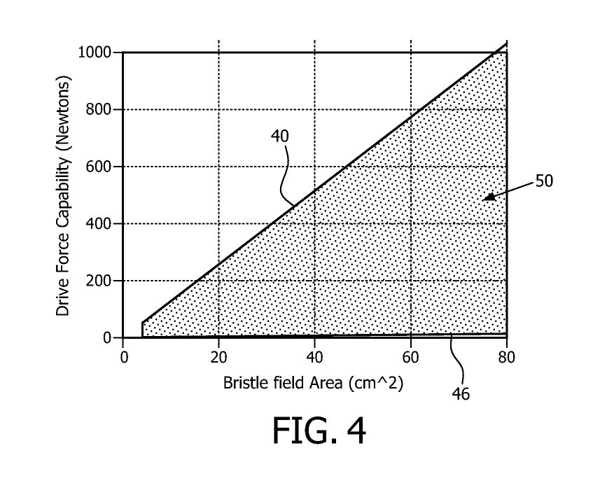

FIG. 4 is a graph showing the minimum and maximum drive force for various bristle field areas, with a bristle field density of 15%.

A mouthpiece appliance for cleaning teeth typically does not require a user to apply force to the appliance against the teeth, i.e. it is typically hands-free, which is one of its advantages. FIG. 1 shows generally a mouthpiece appliance 10 which includes a receptacle assembly 12 into which the teeth of a user are positioned. Typically, receptacle 12 includes upper and lower portions 14 and 16, referred to as trays, for receiving the teeth in the upper and lower jaws of the user. The tray portions may comprise opposing side portions 17, 19 and a front portion 21, each separately driven. Although receptacle 12 shown is capable of receiving all of the teeth of a user, a mouthpiece may be arranged and configured to receive only a portion of the teeth.

The mouthpiece is driven by a drive train assembly 20, which includes a motor 22. A microprocessor may be included but is not necessary. A microprocessor could be used for instance to regulate/control maximum motor force with/and maximum motor current. Positioned on the interior surfaces of the receptacle assembly 12, adjacent the teeth surfaces, are bristle fields, illustrated partially at 24, which contact the inside and outside surfaces of the teeth, as well as the biting (occlusal) surfaces, to produce complete (or partial) teeth cleaning. While various motions of the receptacle 12 can be produced, by various drive train arrangements and receptacle configurations, one effective cleaning motion is a lateral (in-and-out) motion of the bristles toward and away from the surfaces of the teeth. In an alternative, bristle pressure can be created by a bladder or spring arrangement, with bristle motion in a different direction.

An important consideration for effective teeth cleaning with any power oral cleaning appliance, as indicated above, is bristle tip pressure against the teeth. Bristle tip pressure in many such hand-held teeth cleaning appliances, in particular, toothbrushes, is controlled by the user.

Typically, toothbrushes cover only a relatively small brushing area, e.g. one surface of one tooth. This is also a factor in addition to user pressure relative to effective cleaning. As indicated above, current oral hygiene devices, particularly toothbrushes, are not optimized for bristle tip pressure. In fact, investigation of the use of power toothbrushes indicates that the typical amount of bristle tip pressure applied by the user against the teeth is far less than what is optimum for effective cleaning and comfort.

In a mouthpiece teeth cleaning appliance without user control, providing at least the minimum or threshold value of bristle tip pressure to the teeth by mouthpiece action for a selected bristle density necessary to produce effective cleaning is critical to successful operation of the appliance. Further, the drive system/train for the appliance must be able to supply the necessary amount of force to produce at least the minimal threshold bristle tip pressure for the particular bristle density and bristle field (the area covered by the bristles). As indicated above, information of threshold bristle tip pressure and drive force was heretofore not known, which has handicapped the design of a cost-effective mouthpiece. It has been discovered, however, as set forth herein, the value of minimum bristle tip pressure which is necessary to produce effective cleaning of the teeth. This information in turn permits the design of an effective mouthpiece appliance and the operational requirements of the drive train and motor arrangement for the mouthpiece.

The minimum effective bristle tip pressure threshold has been discovered by the inventors herein to be approximately 6 Newtons per cm² of bristle coverage. The minimum bristle field area, which is defined as the area within the minimum outline of the bristles in the mouthpiece, is at least 4 cm² to produce an effective mouthpiece arrangement, and typically will be substantially larger, up to, for instance, the surface area of all of the teeth in a user's mouth. Still further, the bristle density, which is the sum of the cross-sectional area of all of the bristles divided by the bristle field area, is a minimum of 3% for coverage of the tooth surfaces to be cleaned with a reasonable cleaning stroke. The bristle density can be varied upwards from 3%. Specific information is provided herein both for a bristle density of 15%, which appears to be a maximum value for user comfort, and a bristle density of 3%.

From the above information, the drive force capability threshold can be calculated, using the minimum (threshold) bristle tip pressure times the bristle field density. In one example, for a bristle field area of 4 cm², which was indicated to be a minimum for a mouthpiece appliance, and a bristle density of 3%, the minimum force which must be produced by the motor is 0.18 Newtons per cm². It should be recognized that the bristle field area of 4 cm² is generally larger than the largest bristle field area covered by a power toothbrush, which differentiates the mouthpiece arrangement disclosed herein from a typical power toothbrush.

FIG. 2 is a graph showing the minimum drive force capability to achieve the minimum (threshold) bristle tip pressure for various bristle field areas, from 4 cm² up to 100 cm², the entire range of which is greater than the typical power toothbrush. The graph of FIG. 2 plots drive force capability against bristle field area. Diagonal line 30 shows the increase in the threshold drive force capability in Newtons as the bristle field area of the mouthpiece increases. Vertical line 32 is the minimum bristle field area covered by the mouthpiece, e.g. 4 cm². FIG. 2 is based on a minimum bristle density of 3%. The area 34 bounded by lines 30 and 32 reflects an area of operation which produces effective cleaning results for a mouthpiece.

FIG. 3 is a graph also, for a bristle density of 3%, which shows the maximum drive force capability values (as well as the minimum drive force capability values from FIG. 2), as the bristle field increases. FIG. 3 on the horizontal axis references bristle field area, while on the vertical axis is drive force capability of the motor. FIG. 3 illustrates the complete operating area for the mouthpiece relative to the drive force capability of the motor. Line 36 represents the minimum drive force for effective cleaning results for a bristle field area in the range of 4 cm² to 80 cm². This line is comparable to line 30 in FIG. 2, although the drive force divisions are different (larger). The small vertical line 38 is the minimum bristle field area of 4 cm² for the mouthpiece. Diagonal line 40 refers to a maximum drive force, again for a bristle field area from 4 cm² (minimum) to 80 cm². This line defines the maximum drive force relative to maintaining comfort for the user in use of the appliance. Above line 40 for any bristle field area, the motor force produces a bristle tip pressure which is typically uncomfortable for the user. Hence, the area 42 defines the area of desired operation for the mouthpiece, bounded by effectiveness (line 36) and comfort (line 40) for various bristle field areas from 4 cm² to 80 cm².

FIG. 4 shows similar information for a bristle density of 15%. As can be seen, the maximum drive force increases as the bristle field density increases. Similar to FIG. 2, line 46 (comparable to line 30 in FIG. 2) refers to the minimum drive force, while line 48 refers to the maximum drive force. The area 50 bounded by lines 46 and 48 for a bristle field area between 4 cm² and 80 cm² is the area of effective operation while maintaining desired comfort for the user.

The table given below shows a first column of bristle field area, with successive columns indicating minimum drive force and maximum drive force in Newtons for both 3% bristle density and 15% bristle density. The maximum force will vary as the bristle density increases, although the maximum force is the same per unit area for all the values of bristle field areas.

| Bristle | Minimum | Maximum (Comfort) | Maximum (Comfort) |
|---|---|---|---|
| Field | (Efficacy) | Drive Force | Drive Force |
| Area | Drive Force | Capability | Capability |
| (cm²) | Capability | (3% Density) | (15% Density) |
| 4 | 0.72 | 10.272 | 51.36 |
| 10 | 1.8 | 25.68 | 128.4 |
| 20 | 3.6 | 51.36 | 256.89 |
| 30 | 5.4 | 77.04 | 385.2 |
| 40 | 7.2 | 102.72 | 513.6 |
| 50 | 9 | 128.4 | 642 |
| 60 | 10.8 | 154.08 | 770.4 |
| 70 | 12.6 | 179.76 | 898.8 |
| 80 | 14.4 | 205.44 | 1027.2 |

Referring to FIGS. 1 and 1A, receptacle 12 is segmented and driven mechanically by a mechanical drive system 52, comprising a plurality of link arms 54 and pivot points 56 to provide the desired in-and-out movement of the bristles toward and away from the teeth. The link arms, which are connected to the separate tray portions of the receptacle, are driven by motor 22. This is a conventional arrangement for mouthpieces and is hence not described in detail herein. The motor 22 capable of providing the force described above is commercially available from several sources. One example is a Maxon EC45 flat motor. Other available motors can provide the same capability.

Accordingly, the operational characteristics of a mouthpiece have been disclosed which result in effective teeth cleaning but without discomfort to the user, in a hands-free mouthpiece arrangement.

Although a preferred embodiment of the invention has been disclosed for purposes of illustration, it should be understood that various changes, modifications and substitutions may be incorporated in the embodiment without departing from the spirit of the invention, which is defined by the claims which follow.

1. A mouthpiece assembly with effective cleaning capability, comprising:
a mouthpiece receptacle having bristles mounted thereon for contacting and cleaning the teeth, the mouthpiece having at least 4 cm² of bristle field area for contacting the teeth; and
a drive train assembly for driving the mouthpiece such that the bristle field moves toward and away from the surfaces of the teeth, the drive train including a motor providing sufficient drive force to produce a minimum bristle tip threshold pressure of 6 Newtons per cm², for a bristle tip density within the range of 3-15%.

2. The mouthpiece assembly of claim 1, wherein the bristle field moves substantially at a right angle toward and away from the surfaces of the teeth.

3. The mouthpiece assembly of claim 1, wherein the motor has a drive force of at least 0.18 Newtons per cm² of bristle field area.

4. The mouthpiece assembly of claim 1, wherein the bristle field area is within a range of 4 cm² to 80 cm².

5. The mouthpiece assembly of claim 1, wherein the mouthpiece receptacle is capable of receiving substantially all of the teeth of a user, and wherein the bristle field covers all of the teeth received by the receptacle.

6. The mouthpiece assembly of claim 1, wherein the force produced by the motor is controlled so that the bristles produce effective cleaning with bristle tip pressures of at least 6 Newtons per cm² and greater while limiting the force to a maximum value which is comfortable for the user, approximately 85 Newtons per cm², or less.
